(19) United States
(12) Patent Application Publication
(10) Pub. No.: US 2009/0097064 A1
(43) Pub. Date: Apr. 16, 2009

(54) PRINTING APPARATUS, JOB PROCESSING METHOD, PROGRAM, AND STORING MEDIUM

(75) Inventor: Masahiko Tominaga, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/251,098

(22) Filed: Oct. 14, 2008

(30) Foreign Application Priority Data
Oct. 15, 2007 (JP) 2007-268010

(51) Int. Cl. G06F 3/12

(52) U.S. Cl. 358/1.15

(57) ABSTRACT

A printing apparatus which enables to efficiently improve the productivity of the printed matter and to efficiently supply the resource. It is determined whether a printing interrupting factor occurs regarding a job for which a printing process is performed. When it is determined that the printing interrupting factor occurs regarding the job, a subsequent job following the job is controlled to be performed in priority to the job. When the job, regarding which, it is determined that the printing interrupting factor occurs, is the job related to image quality adjustment, the subsequent job is restricted to be performed in priority to the job regarding which, it is determined that the printing interrupting factor occurs.

### BACKGROUND OF THE INVENTION

1. Field of the Invention

The present invention relates to a printing apparatus, a job processing method, a program, and a storing medium.

2. Description of the Related Art

In a conventional printing apparatus, particularly in a printing apparatus for the POD (Print On Demand) system, there is a problem of how to reduce a downtime of the printing apparatus to improve the productivity of the printing.

Japanese Laid-Open Patent Publication (Kokai) No. 2007-65898 proposes a configuration for improving the productivity of the printing. In this technique, when regarding a job, a printing interrupting factor, which is a shortage in printing resources such as a sheet or toner necessary for executing the job or the like, occurs, another job is executed instead of indefinitely waiting for a supply of the resource. Thereby, the downtime of the printing apparatus is reduced.

In addition, the printing apparatus for the POD system is highly demanding in image quality. Thus, it is necessary to periodically adjust the image quality to avoid influence of a change in the environment such as humidity and temperature, and a change in a characteristic because of a worn component of the printing apparatus, or the like. The printing apparatus executes a job for a measurement page to adjust the image quality. This job for the measurement page is treated similarly to a normal job. Specifically, the printing apparatus generates the job for the image quality adjustment and executes the job for the image quality adjustment. A user instructs the printing apparatus to scan the measurement page printed by the execution of the job for the image quality adjustment. Based on the scanned result, the printing apparatus adjusts the image quality by adjusting a value in a density conversion table or a color space conversion table.

However, in the technique in Japanese Laid-Open Patent Publication (Kokai) No. 2007-65898, when regarding the job for the image quality adjustment, the printing interrupting factor, such as a shortage in some of the resources necessary for the printing, occurs, the printing of another job is executed in priority to the job for the image quality adjustment. As a result, the execution of the image quality adjustment is postponed, and although the productivity is increased, the satisfactory image quality can not be obtained. This has been a problem.

On the other hand, in order to ensure the execution of the image quality adjustment, it is necessary to eliminate the printing interrupting factor; for example, it is necessary to previously provide the resources so as to avoid the shortage in the resources necessary to execute the job for the image quality adjustment, which makes operations complex.

### SUMMARY OF THE INVENTION

The present invention provides a printing apparatus, a job processing method, a program, and a storing medium, which overcome the above-described problem.

In a first aspect of the present invention, there is provided a printing apparatus for performing a printing processing of a job, comprising a first determining unit adapted to determine whether a printing interrupting factor occurs regarding the job for which the printing processing is performed, a control unit adapted to control to perform a subsequent job following the job in priority to the job, when the first determining unit determines that the printing interrupting factor occurs regarding the job, and a restriction unit adapted to restrict, when the job, regarding which, it is determined that the printing interrupting factor occurs, is the job related to image quality adjustment, the subsequent job to be performed in priority to the job regarding which, it is determined that the printing interrupting factor occurs.

Other objects and features of the present invention will become apparent, for example, from the following specification and drawings.

### BRIEF DESCRIPTION OF THE DRAWINGS

The accompanying drawings, which are incorporates in and constitute a part of the specification, illustrate embodiments of the invention and, together with the description, serve to explain the principle of the invention.

FIG. 1 is a schematic diagram of an image forming system provided with a printing apparatus according to a first embodiment of the present invention.

FIG. 2 is a block diagram illustrating a configuration of an MFP in FIG. 1.

FIG. 3 is a block diagram illustrating a detailed configuration of an MFP control section in FIG. 2.

FIG. 4 is a schematic cross-section view illustrating a configuration of a printer section in FIG. 2.

FIG. 5 is a block diagram illustrating a detailed configuration of a RIP section in FIG. 2.

FIG. 6 is a front external view illustrating an example of an operation section in FIG. 2.

FIG. 7A and FIG. 7B are diagrams exemplifying a job condition screen displayed on a touch panel section in FIG. 6.

FIG. 8 is a flowchart showing the procedure of a printing process executed by the MFP functioning as the printing apparatus according to the present embodiment.

FIG. 9A and FIG. 9B are diagrams exemplifying a user mode screen.

FIG. 10 is a diagram exemplifying a main screen of an image quality adjusting tool.

FIG. 11 is a flowchart showing the procedure of the efficient printing process under the image quality adjustment in the present embodiment.

FIGS. 12A and FIG. 12B are diagrams illustrating a setting screen when a job is interrupted.

FIG. 13 is a flowchart showing the procedure of the printing process under the consideration of the image quality adjustment, which is executed by the MFP functioning as the printing apparatus according to a second embodiment of the present invention.

FIG. 14 is a flowchart showing the procedure of the printing process executed by the MFP functioning as the printing apparatus according to a third embodiment of the present invention.

### DESCRIPTION OF THE EMBODIMENTS

Embodiments of the present invention will be described below as referring to the drawings.

<System Configuration>

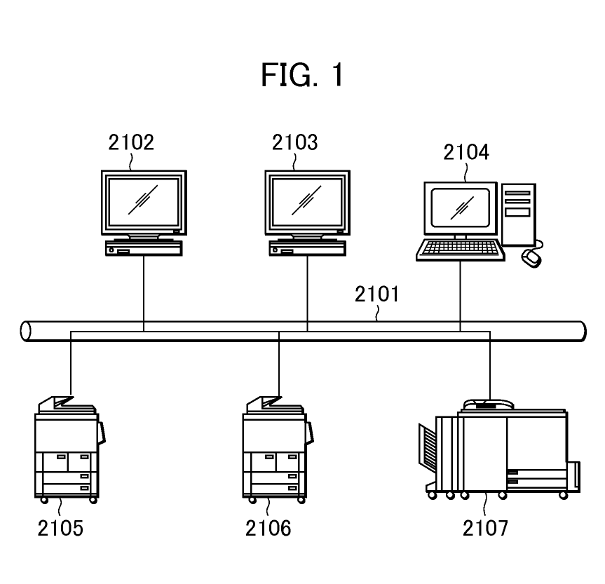

FIG. 1 is a schematic diagram of an image forming system provided with a printing apparatus according to a first embodiment of the present invention.

A network 2101 is connected to personal computers (PC) 2102 to 2104 functioning as an information processing apparatus, and MFPs 2105 to 2107 functioning as an image forming apparatus. Hereinafter, a term “PC” is used to collectively denote the PCs 2102 to 2104, and a term “MFP” is used to collectively denote the MFPs 2105 to 2107. The MFP is an abbreviation of Multi Function Peripheral. Although not illustrated in FIG. 1, it is apparent that the image forming system may be made up of many PCs or MFPs connected other than the above PCs or MFPs.

The PC includes standard components mounted on a general purpose computer (for example, a CPU, a RAM, a ROM, a hard disk, an external storing apparatus, a network interface, a display, a keyboard, a mouse, and the like).

<Configuration of MFP>

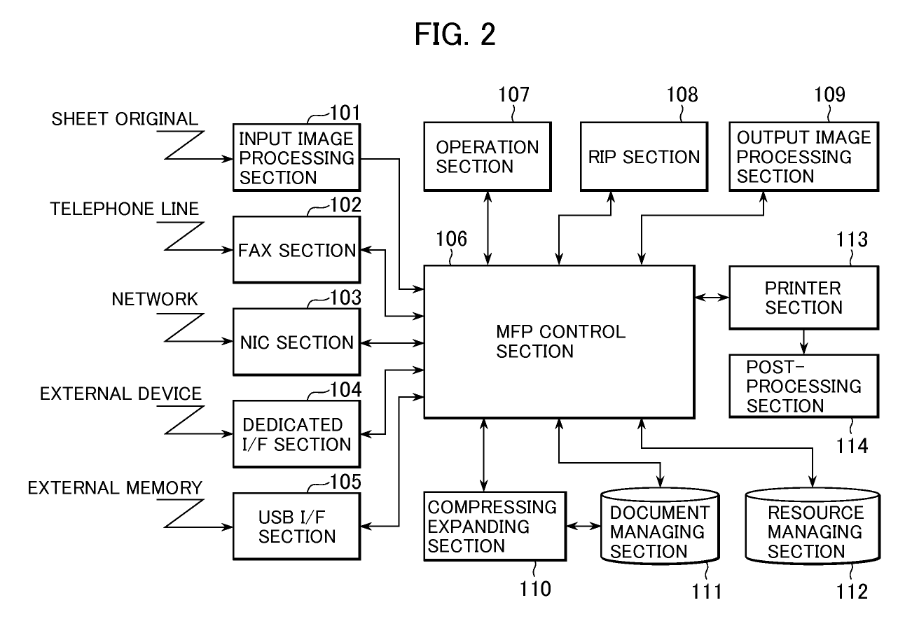

Next, a configuration of the MFP will be described by using FIG. 2.

FIG. 2 is a block diagram illustrating a configuration of the MFP in FIG. 1.

As illustrated in FIG. 2, the MFP is provided with: an input image processing section 101; a FAX section 102; an NIC (Network Interface Card) section 103; a dedicated I/F section 104; and a USB I/F section 105. In addition, the MFP is provided with: an MFP control section 106; an operation section 107; an RIP section 108; an output image processing section 109; a compressing expanding section 110; a document managing section 111; a resource managing section 112; a printer section 113; and a post-processing section 114.

The input image processing section 101 is, for example, a scanner, which reads an image on a sheet original or the like and executes image-processing for the read image data. The input image processing section 101 may be provided with an ADF (Automatic Document Feeder), and can automatically transport, by using the ADF, a plurality of originals to an image reading section to continuously read the transported originals.

The FAX section 102 transmits and receives the image data by utilizing a telephone line typified by a facsimile, or the like.

The NIC section 103 transmits and receives, by utilizing the network 2101, the image data and apparatus information to and from the external information processing apparatus such as the PC.

The dedicated I/F (interface) section 104 exchanges information such as the image data with the external information processing apparatus.

The USB I/F (Universal Serial Bus interface) section 105 transmits and receives data such as the image data to and from a USB apparatus typified by a USB memory (a type of a removable medium).

In the following description, the input image processing section 101, the FAX section 102, the NIC (Network Interface Card) section 103, the dedicated T/F section 104, and the USB I/F section 105 are also referred to as an input section since such sections are used when inputting the image data.

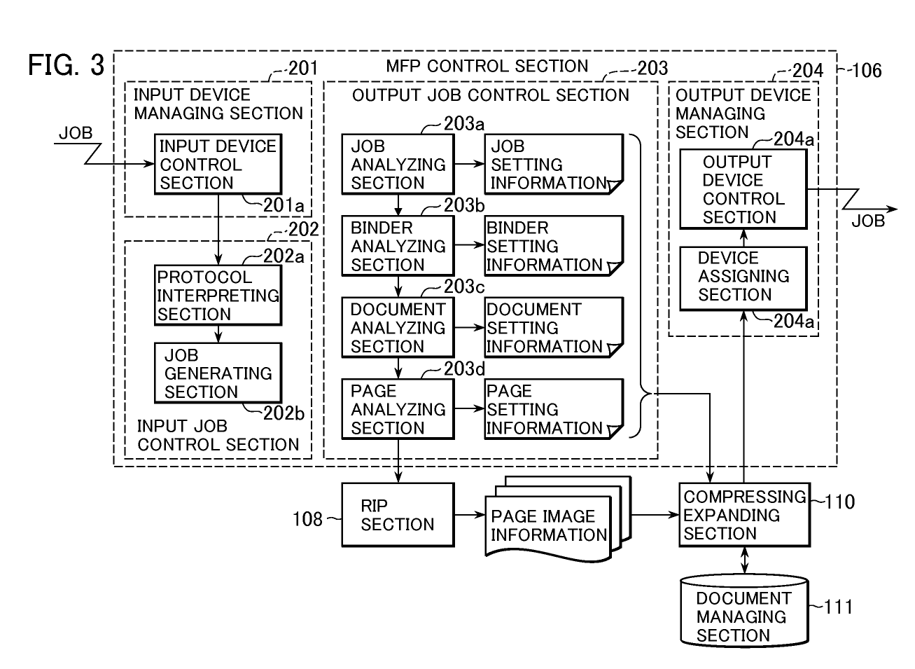

The MFP control section 106 includes a not-illustrated ROM, a not-illustrated RAM, and the like, and executes a program stored in the RAM to totally control the processing executed in the MFP. For example, the MFP control section 106 stores the image data inputted from the input image processing section 101, the NIC section 103, and the dedicated I/F section 104 in a storing section such as the document managing section 111. The MFP control section 106 reads as necessary the image data stored in the document managing section 111, transfers the read image data to an outputting section such as the printer section 113, and causes the printer section 113 to execute the printing processing. According to an instruction from an operator, the MFP control section 106 transmits the image data read from the document managing section 111 to the PC and other image forming apparatus through the network 2101. The MFP control section 106 will be described in detail later by using FIG. 3.

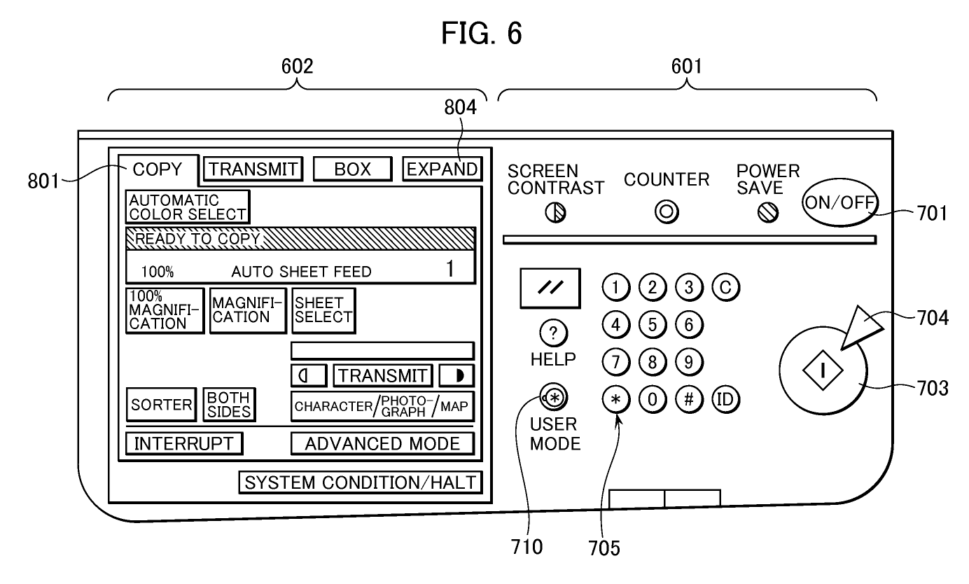

The operation section 107 receives an operation and an instruction from the user. The operation section 107 will be described in detail later by using FIG. 6.

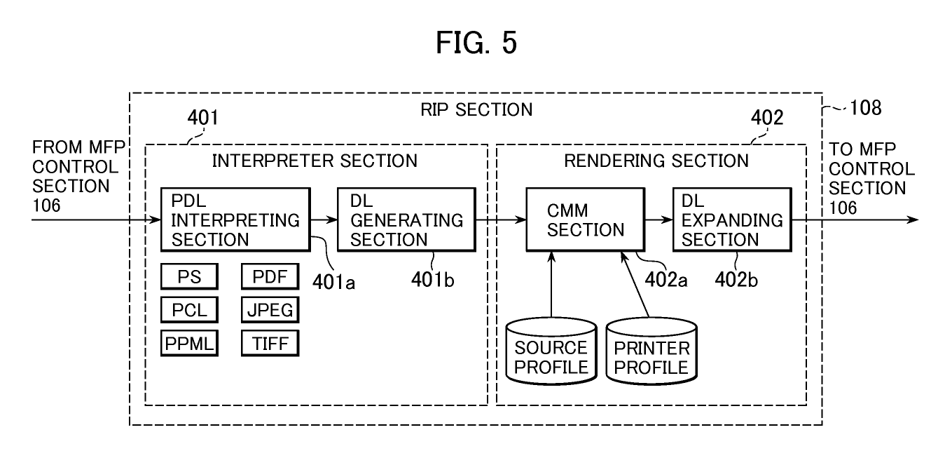

The RIP section 108 executes an RIP (Raster Image Processor) processing for inputted PDL (Page Description Language) data. As to the RIP section 108, detailed description is set forth below by using FIG. 5. The output image processing section 109 executes an image processing for the printing for an image to be printed. The compressing expanding section 110 compresses or expands the image data. The MFP control section 106 executes a variety of processings for the image data by using the RIP section 108, the output image processing section 109, or the compressing expanding section 110.

The document managing section 111 is made up of the storing apparatus such as a hard disk, and can store the image data. For example, the document managing section 111 can store the image data inputted from the input image processing section 101, the FAX section 102, the NIC section 103, and the dedicated I/F section 104. As necessary, the MFP control section 106 may cause the compressing expanding section 110 to compress the image data to store the compressed image data. When reading the compressed image data stored in the document managing section 111, the MFP control section 106 executes the expanding processing for the image data to be read.

The resource managing section 112 stores data such as a font, a color profile, and a variety of parameter tables which are commonly used in a variety of image processings such as a gamma table. The MFP control section 106 can call such data when necessary, and control the resource managing section 112 so that the parameter table can be newly stored or modified to update.

The printer section 113 prints the image data transmitted by the MFP control section 106. The post-processing section 114 executes, as necessary, a sorting processing and a finishing processing for a print sheet printed out by the printer section 113.

By using the above configuration, the MFP control section 106 can execute a copy job, a print job, a scan job, and a data transmission job. When executing the copy job, the MFP control section 106 reads the image data from the input section such as the input image processing section 101, and stores the read image data in the document managing section 111. The MFP control section 106 causes the printer section 113 to print the image data read from the document managing section 111 based on the setting received from the user through the operation section 107. The MFP control section 106 causes, as necessary, the post-processing section 114 to execute the post-processing.

When executing the print job, the MFP control section 106 stores the image data transmitted from the external information processing apparatus such as the PC in the document managing section 111. The MFP control section 106 causes the printer section 113 to print the stored image data based on the setting received from the user through the operation section 107. The MFP control section 106 causes, as necessary, the post-processing section 114 to execute the post-processing.

When executing the scan job, the MEFP control section 106 reads the image data from the input section such as the input image processing section 101, and stores the read image data in the document managing section 111.

When executing the data transmission job, the MFP control section 106 reads the image data stored in the document managing section 111, and transmits the read image data to the external information processing apparatus such as the PC based on destination information set by the user.

As described above, the MFP can execute a plurality of types of the jobs.

While the MFP includes a full color apparatus and a monochrome apparatus, in the present embodiment, the full color apparatus will be described as an example. The present image forming system may be made up of the MFP which is the multiple function-type image forming apparatus provided with a plurality of functions, and the SFP which is the single function-type image forming apparatus provided with only the print function, or may be made up of any one type of the image forming apparatuses. The SFP denotes Single Function Peripheral.

<Detailed Configuration of MFP Control Section 106>

Next, a detailed configuration of the MFP control section 106 will be described by using FIG. 3.

FIG. 3 is a block diagram illustrating a detailed configuration of the MFP control section 106 in FIG. 2.

The detailed configuration of the MEP control section 106 illustrated in FIG. 3 includes following four main sections, that is, an input device managing section 201 managing an input device, an input job control section 202 interpreting an inputted job, an output job control section 203 organizing a variety of pieces of setting information on the job, and an output device managing section 204 assigning an output device to the job.

The input device managing section 201 functions to organize input signals from respective input sections (input devices) of the MFP of FIG. 2. Here, the input section denotes, for example, the input image processing section 101, the FAX section 102, the NIC (Network Interface Card) section 103, the dedicated I/F section 104, and the USB I/F section 105.

The input device managing section 201 includes an input device control section 201a, and the input device control section 201a receives the input signal through each input section. This input signal is an image signal of a scanned sheet original inputted from the input image processing section 101, a PDL data signal received from the network 2101, or the like. This input signal includes the image data stored in the document managing section 111, and the image data which is cooperatively processed by the RIP section 108 and the output image processing section 109.

The input job control section 202 is made up of: a protocol interpreting section 202a; and a job generating section 202b. A series of operation requests transferred from the input device control section 201a are instruction signals referred to as a command (protocol), and are received by the input job control section 202. The received operation request is interpreted by the protocol interpreting section 202a to convert to a comprehensible operation procedure in the MFP.

On the other hand, based on a result of the interpretation by the protocol interpreting section 202a, the job generating section 202b generates a variety of jobs such as the print job, the scan job, a PDL expanding job, a facsimile receiving job. The generated job is each defined a scenario indicating to what processing the job is to be subjected in the MFP and where it is to be sent, and the generated job flows in the MFP according to the scenario.

Based on the input signal received through the input section, the output job control section 203 generates a variety of the setting information and image information on the job in a job analyzing section 203a, a binder analyzing section 203b, a document analyzing section 203c, and a page analyzing section 203d. A variety of the setting information on the job is also referred to as job tickets.

The job analyzing section 203a analyzes the detail of the setting information (job setting information) on the whole job such as a name of a document to be printed, the number of the documents, discharge tray designation for an output destination, a binder order of the job made up of a plurality of binders.

The binder analyzing section 203b analyzes the detail of the setting information (binder setting information) on the whole binder such as the setting of the book-binding, a position of a staple, and a document order of the binder made up of a plurality of documents.

The document analyzing section 203c analyzes the detail of the setting information (document setting information) on the whole document such as a page order of the document made up of a plurality of pages, a designation of the both sides printing, and addition of a cover and an interleaved sheet.

The page analyzing section 203d analyzes the detail of the setting information (page setting information) on the whole of a variety of setting pages such as resolution of an image, a direction of an image (landscape/portrait).

In addition, when the PDL data is inputted from the input section, the MFP control section 106 causes the RIP section 108 to execute the RIP processing to generate page image information. The MFP control section 106 causes the compressing expanding section 110 to compress the generated page image information, and thereafter, stores the compressed page image information in the document managing section 111 while correlating with a variety of types of the setting information. In this case, the MFP control section 106 may compress and store a variety of types of the setting information in addition to the page image information.

The output device managing section 204 is made up of: an output device control section 204a; and a device assigning section 204b. The MFP control section 106 causes the compressing expanding section 110 to expand the page image information stored in the document managing section 111, and reads the expanded page image information along with a variety of types of the related setting information.

Based on each defined scenario of the job, the device assigning section 204b assigns the output device to the job. In such a case, when a plurality of the jobs simultaneously execute each processing, the device assigning section 204b arbitrates in outputting disputes between the plurality of the jobs. Based on a result of the arbitration by the device assigning section 204b, the output device control section 204a schedules to output a sheet of the each job to be executed to one of the output sections, such as the printer section 113 and the post-processing section 114.

<Detailed Configuration of the Printer Section 113>

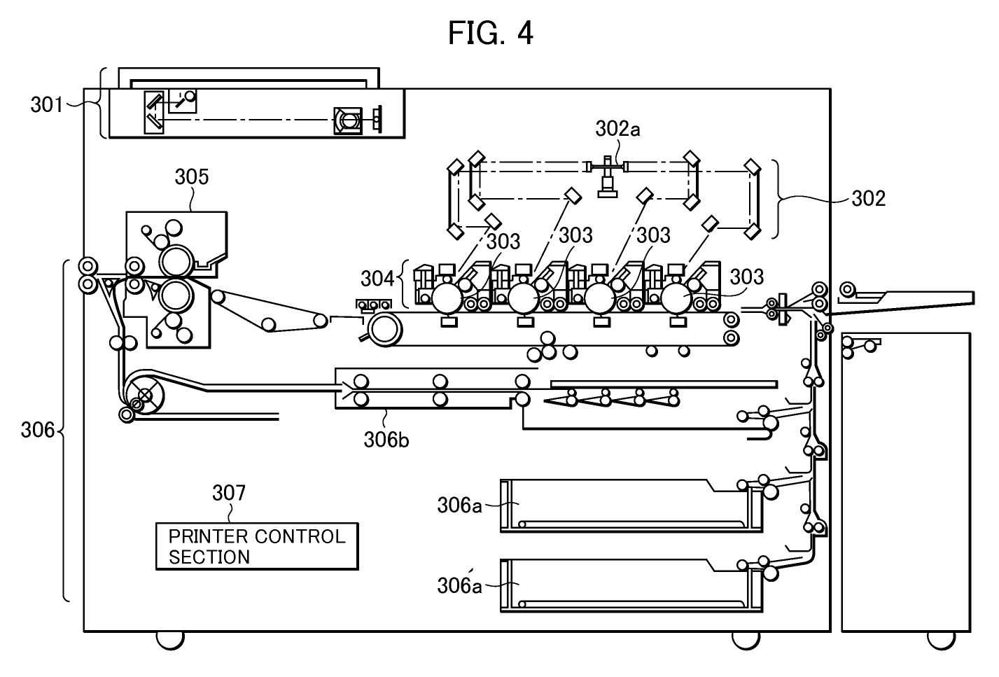

Next, as a configuration of the printer section 113, a configuration of the four-D color MFP provided with four photosensitive drums will be described by using FIG. 4.

FIG. 4 is a schematic cross-section view illustrating a configuration of the MFP including the printer section 113 in FIG. 2.

The four-D color MFP uses recording material (for example, toner) with four colors of Cyan (C), Magenta (M), Yellow(Y), and Black (B) to realizes the color printing. The four-D color MFP is mainly made up of: a scanner section 301: a laser exposing section 302, a photosensitive drum 303; an imaging section 304; a fixing section 305; a paper-feeding/transporting section 306; and a printer control section 307 controlling these sections.

The scanner section 301 radiates light to an original placed on a platen to optically read an original image, and converts the read image to an electrical signal to generate the image data. The laser exposing section 302 causes a light beam, such as laser light, which is modulated according to the image data, to impinge onto a rotating multiple faceted mirror (polygon mirror) 302a rotating at a constant angular velocity to radiate the light beam as reflected scanning light onto the photosensitive drum 303.

The imaging section 304 is realized by including four series of developing units (developing stations) of a series of electro-photographic processes. This series of the electro-photographic processes include processes of rotating the photosensitive drum 303, electrically-charging the drum by an electrical charger, and developing by means of the toner a latent image formed by the laser exposing section 302 on the photosensitive drum 303. Further, the electro-photographic processes include processes of transferring the toner image to a print sheet (also referred to as a sheet), and collecting the microscopic toner which has not been transferred and remains on the photosensitive drum 303.

In the four series of the developing units, which are arranged in the order of Cyan (C), Magenta (M), Yellow (Y), and Black (B), after a predetermined time is passed over when the imaging by the developing unit for Cyan (C) is started, the imaging operations by the developing units for Magenta (M), Yellow(Y), and Black (B) are sequentially executed. With such a timing control, a full color toner image without a color shift is transferred on the sheet.

The fixing section 305 is made up of a combination of a roller and a belt, incorporates a heat source such as a halogen heater, and dissolves and fixes by heat and pressure the toner on the sheet to which the toner image is transferred by the imaging section 304.

The paper-feeding/transporting section 306 includes one or more sheet feeder 306a typified by a sheet cassette or a paper deck. According to an instruction from the printer control section 307, the paper-feeding/transporting section 306 isolates one sheet from a plurality of the sheets stored in the sheet feeder 306a, and transports the isolated sheet to the imaging section 304 and the fixing section 305. The toner images of respective colors are transferred by the above developing unit on the transported sheet, and the full color toner image is finally formed on the sheet. When the images are formed on both sides of the sheet, the sheet, which has passed through the fixing section 305, is controlled so as to pass through a both side transporting path 306b which transports the sheet again to the imaging section 304.

The printer control section 307 communicates with the MFP control section 106 controlling the whole MFP, and controls the printing processing according to an instruction of the MFP control section 106. In addition, the printer control section 307 manages a condition of each section of the scanner section 301, the laser exposing section 302, the imaging section 304, the fixing section 305, and the paper-feeding/transporting section 306, and instructs each section so that all the sections can operates harmoniously and smoothly.

The sheet having passed through the fixing section 305 passes through an image reading sensor section on a transporting path, and the image data printed on the sheet is read by this image reading sensor section. The read image data is used to measure the density of an output image or to inspect whether or not the output image has any abnormalities.

<Detailed Configuration of the RIP Section 108>

Next, the detailed configuration of the RIP section 108 will be described by using FIG. 5.

FIG. 5 is a block diagram illustrating the detailed configuration of the RIP section 108 in FIG. 2.

The RIP processing is a processing for expanding to a bitmap (raster image), vector information such as a character described by the PDL, a line drawing, a figure, or object information such as a color, a pattern, and image scanning line information on a photograph, or the like.

The RIP section 108 is generally made up of two sections of: an interpreter section 401; and a rendering section 402.

The interpreter section 401 is made up of: a PDL interpreting section 401a interpreting the PDL data; and a DL (Display List) generating section 401b generating an intermediate file, referred to as a display list, from the interpreted PDL data.

On the other hand, the rendering section 402 is made up of: a CMM section 402a color-matching for the display list; and a DL expanding section 402b expanding the display list to the bitmap (raster image). CMM is an abbreviation of Color Matching Module.

The PDL interpreting section 401a is a section analyzing a variety of types of the inputted PDL data. It is possible to cause the CMM section 402a to input a variety of the image data expressed in a general color space such as gray scale, RGB, and CMYK. In the case of other color space, after the image data is firstly converted to the CMYK space with the CRD (Color Rendering Dictionary), color matching therefor is applied. The color adjusting is executed with an ICC profile in the CMM section 402a.

The ICC profile includes a source profile and a printer profile. The source profile is used for firstly converting an RGB (or CMYK) data to a standardized L*a*b* space, and further converting this L*a*b* data to the CMYK space which is suitable to a targeted printer. In this case, the source profile is made up of: a RGB profile; and a CMYK profile.

Settings for the printer profile are generated according to color characteristics of each printer, and in the case of printing an RGB type image, it is preferable to select Perceptual (color priority) setting or Saturation (brightness priority) setting. In the case of printing a CMYK type image, Colorimetric (minimum color difference) setting is often selected to output the optimal image.

The ICC profile is generally generated in a lookup table format. The RGB (or CMYK) data is inputted in the CMM section 402a to be uniquely converted to the L*a*b* data with the source profile. By contraries, the L*a*b* data is converted with the printer profile to the CMYK data which is suitable to the printer.

The RGB data, which does not need the color matching, is converted to the CMYK data with a default color conversion to be outputted. The CMYK data, which does not need the color matching, is directly outputted.

The image data expanded by this RIP section 108 is stored in the document managing section 111 through the compressing expanding section 110.

<Configuration of the Operation Section 107>

Next, an example of the operation section 107 will be described by using FIG. 6.

FIG. 6 is a front external view illustrating an example of the operation section 107 in FIG. 2.

The operation section 107 of the MFP is made up of: a key input section 601; and a touch panel section 602.

The key input section 601 is a key input section in which the normal operation setting can be executed, and is provided with: a power switch 701; a start key 703; a stop key 704; a ten-key numeric keypad 705; a user mode key 710; and the like. The start key 703 is a key for instructing the start of a variety of processings such as a copy and a transmission, and the stop key 704 is a key for interrupting the start of a variety of the processings. The ten-key numeric keypad 705 is a key for placing a number for a variety of settings. The user mode key 710 is a key for shifting to a system setting screen for each user.

On the other hand, the touch panel section 602 is made up of: an LCD (Liquid Crystal Display); and a touch panel display made of transparent electrodes applied thereon. Here, the processing is previously programmed, in which, when a key-corresponding part on the transparent electrode displayed on the LCD, is touched by a user's finger, other operation screen is displayed by detecting the touch. The exemplified screen of FIG. 6 is an initial screen in a standby mode, and a variety of operation screens can be displayed according to a setting operation. In this initial screen, the following keys are, for example, arranged: a copy tab key 801 for transiting to the operation screen of a copy operation; and an expand tab key 804 for transiting to the setting screen for setting an expansion function such as scanner setting and printer setting.

<Job Condition Screen>

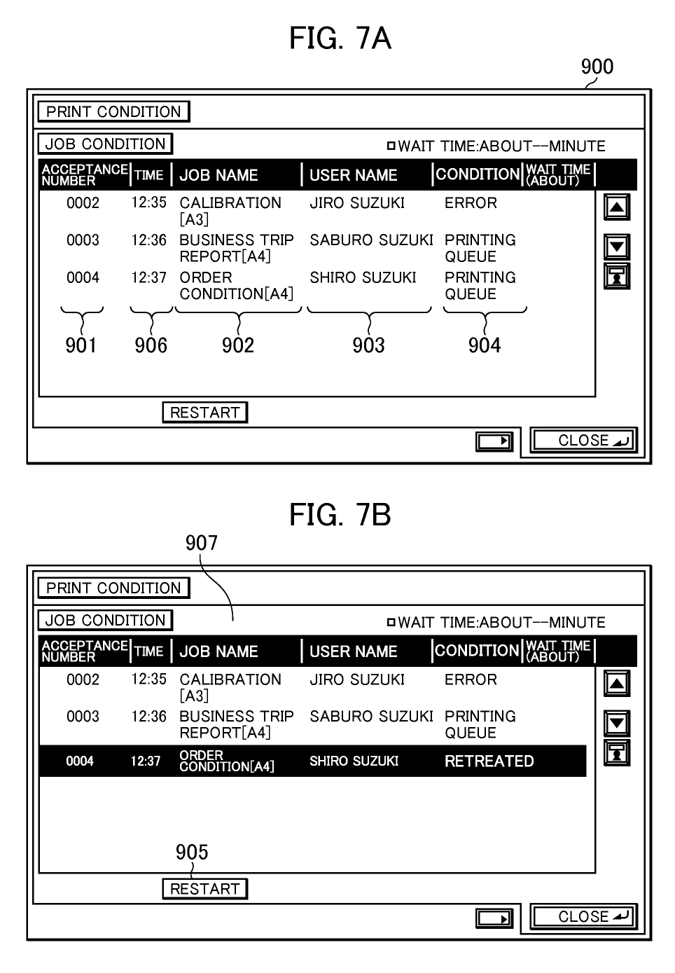

Next, a job condition screen of the job, whose printing is being executed or is waited for, will be described by using FIG. 7A and FIG. 7B.

FIG. 7A and FIG. 7B are diagrams exemplifying the job condition screen displayed on the touch panel section 602 in FIG. 6.

When the expand tab key 804 on the touch panel section 602 is selected, a job condition screen 900 is displayed. This job condition screen 900 displays a job list which is a list of jobs whose printing to be executed by the MFP is not completed. Reference numeral 901 denotes an acceptance number which distinguishes the jobs from each other and indicates accepting orders thereof in the MFP. Job accepting times 906, job names 902, names 903 of respective users who set for the jobs to be executed, and job conditions 904 are also displayed. Each of the job conditions 904 displayed here expresses the following job condition.

“Printing” indicates such a condition that the printing of the job is being executed.

“Printing Queue” indicates either one of such a condition that the job is waiting for its turn for printing, or such a condition that the job is in its turn for the printing, and the image to be printed is being prepared to start printing the job.

“Error” indicates such a condition that, although the job is in its turn for the printing, the printing can not be executed because of the shortage of a resource for executing the printing of the job, or influence of a printing interrupting factor such as a jam while the job is being executed, or such a condition that the printing can not be executed since the shortage of a resource to continue the printing, or the printing interrupting factor such as the jam is induced while the printing of the job is being executed (printing).

“Retreating” indicates such a condition that the job is temporarily retreated to the document managing section 111.

The resource for executing the above printing means a variety of resources which are necessary for the printing of the job in the MFP. Specifically, a variety of the resources include a print sheet used for the printing (including a sheet size, a sheet type, and the like), recording material (toner), a post-processing function (punch, staple, and the like), a memory capacity, and the like. The MFP control section 106 refers to detection information of a sensor, and the like to manage the condition of the resource (e.g. shortage thereof) For example, the MFP control section 106 determines based on a signal from a not-illustrated sensor provided in the sheet feeder 306a whether or not the sheet is in the sheet feeder 306a. The MFP control section 106 can also execute a similar controlling for the both side transporting path 306b. As to other resources, the MFP control section 106 can also determines, based on the signal from the not-illustrated sensor provided in a location of each of other resources, whether or not there exists each of other resources.

On the other hand, when the reprinting is executed for the job whose condition is “retreating”, the job is selected on the job condition screen 900, and a restart key 905 of FIG. 7B is pressed down to cause the job to wait for its printing turn. Reference numeral 907 exemplifies such a condition that the job in “retreating” is selected, and the restart key 905 can be pressed down.

<Printing Processing>

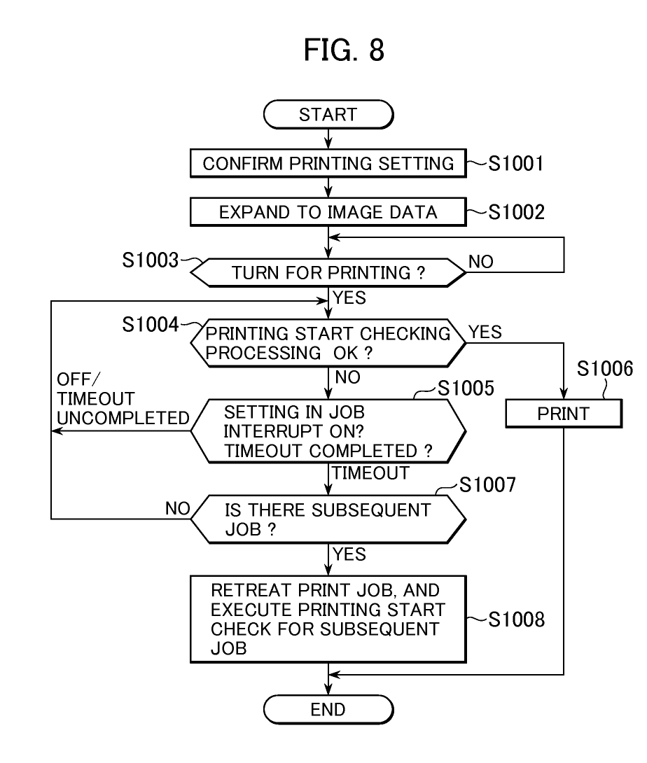

Next, the printing processing by the MFP, particularly, the printing processing efficiently continued by the MFP will be described by using FIG. 8.

FIG. 8 is a flowchart showing the procedure of the printing process executed by the MFP functioning as the printing apparatus according to the present embodiment.

After receiving the print job, the MFP control section 106 causes the job analyzing section 203a to analyze the job setting information, and confirms a printing setting (step S1001). When the confirmation of the printing setting is completed, the MFP control section 106 causes the RIP section 108 to execute an expanding processing for the image data based on the analyzed job setting information (step S1002). Here, at a time when the analysis of the job setting information is completed, the MFP control section 106 displays, as exemplified in FIG. 7A and FIG. 7B, information on the job in the job list displayed on the touch panel section 602.

When the expanding processing is completed, the MFP control section 106 causes the job to wait in step S1003 until its turn comes around for the job to execute the printing. In this case, the MFP control section 106 displays the condition of the job as “Printing Queue” in the job list. When it is determined in step S1003 that the job's turn has come for the printing, the MFP control section 106 executes, in step S1004, a printing start checking processing for the job. The printing start checking processing is such a processing that, based on the printing setting confirmed in step S1001 and a result of the expanding in step S1002, it is determined whether or not the resource, which is necessary to execute the printing of the print job to be processed, is assembled in the printing apparatus. In other words, the printing start checking processing is such a processing that it is determined whether regarding the print job to be processed, the printing interrupting factor occurs.

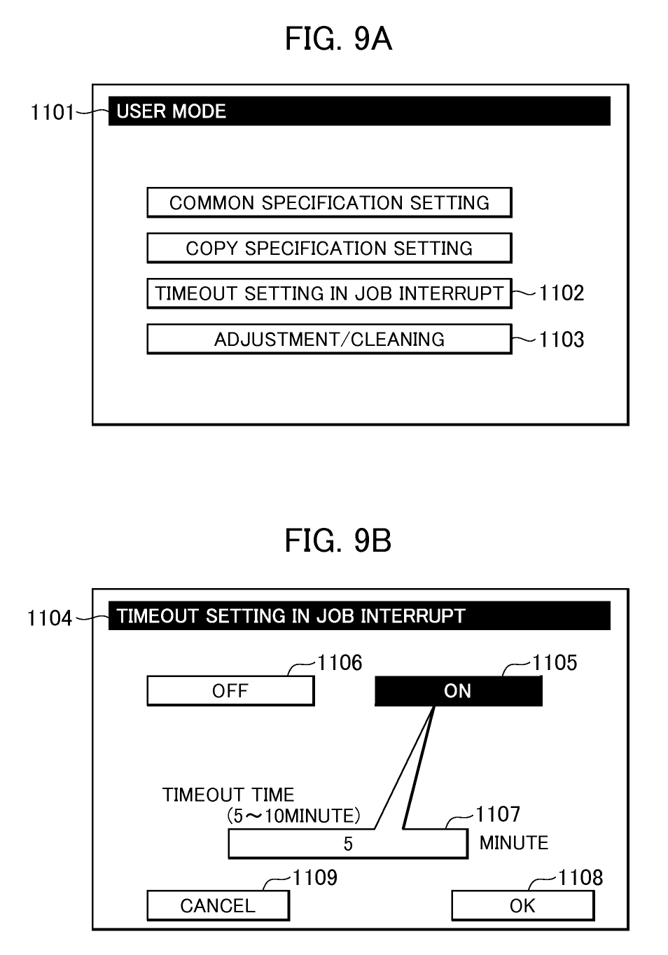

When, in the printing start checking processing, it is determined that the printing interrupting factor occurs, that is, when the MFP control section 106 determines that there is a shortage in some of the resources necessary for the printing of the job (NO in step S1004), according to the setting made by “timeout setting in a job interrupt” as described below in step S1005, the MEP control section 106 waits for the supply of the lacking resource, which is necessary to execute the printing, to be supplied. The “timeout setting in a job interrupt” is information that is set in a user mode screen exemplified in FIG. 9A and FIG. 9B, and held in the MEP control section 106.

When detecting that the user mode key 710 on the key input section 601 is pressed down, the MFP control section 106 displays a user mode screen exemplified in reference numeral 1101 of FIG. 9A in the touch panel section 602. Buttons for executing a variety of types of setting for the MEFP are provided in this user mode setting screen 1101. For example, such buttons are made up of a common specification setting button, a copy specification setting button, a “timeout setting in a job interrupt” button 1102, an adjustment/cleaning button 1103, and the like.

While the screen 1101 is being displayed, when detecting that the “timeout setting in a job interrupt” button 1102 is pressed down, the MFP control section 106 displays a timeout setting in a job interrupt screen (switching unit) exemplified in Reference numeral 1104 of FIG. 9B. The timeout setting in a job interrupt screen 1104 includes an ON key 1105 and an OFF key 1106, and when the ON key 1105 is selected, a timeout time can be set in an area 1107.

When detecting that an OK key 1108 is pressed down, the MFP control section 106 updates “timeout setting in a job interrupt” information in the MFP control section 106 to the setting made on the timeout setting in a job interrupt screen 1104. The MFP control section 106 closes the timeout setting in a job interrupt screen 1104 to display the user mode setting screen 1101. When detecting that a cancel key 1109 is pressed down, the MFP control section 106 does not update the “timeout setting in a job interrupt” information in the MFP control section 106, and closes the timeout setting in a job interrupt screen 1104.

When the “timeout setting in a job interrupt” is OFF (OFF in step S1005), the MFP control section 106 continues in step S1004 to wait for the sheet to be supplied. On the other hand, when the “timeout setting in a job interrupt” is ON, the MFP control section 106 waits for the supply of the lacking and necessary resource until a time set in the timeout time 1107 of the timeout setting in a job interrupt screen 1104 has passed (uncompleted timeout in step S1005).

When the MFP control section 106 determines in step S1004 that the resource necessary for executing the printing has been assembled (YES in step S1004), the MFP control section 106 starts printing the job in step S1006. On the other hand, when there is still a shortage in the resource necessary for the printing of the job even after the time set in the timeout setting 1107 has passed over in step S1005 (timeout in step S1005), the MFP control section 106 determines whether or not there exists a job (subsequent job) waiting for its turn for printing after the job in step S1007.

When the MFP control section 106 determines that there exists a job waiting for its turn for printing after the job (YES in step S1007), the MFP control section 106 temporarily moves the print job to the document managing section 111 to cause the print job to be retreated in step S1008. The MFP control section 106 further executes the printing start checking processing for the job waiting for its turn for printing after the print job which is caused to be retreated.

The print job may be retreated in step S1008 regardless of the determination result in step S1007 whether or not there exists the subsequent job.

<Procedure for Adjusting Image Quality>

Next, a procedure for adjusting image quality in the present system will be described.

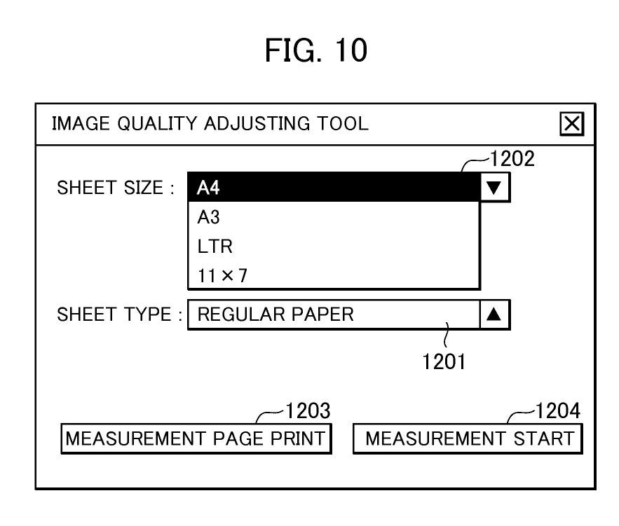

First, when the user wishes to execute an image quality adjustment, the user starts an image quality adjusting tool in the PCs 2102 to 2104. The image quality adjusting tool is an application installed in the PCs 2102 to 2104. When detecting that the image quality adjusting tool is started, the PCs 2102 to 2104 display a main screen of the image quality adjusting tool as exemplified in FIG. 10.

In FIG. 10, Reference numeral 1201 denotes a menu for setting a sheet type of the measurement page for the image quality adjustment, and Reference numeral 1202 denotes a menu for setting a sheet size. Reference numeral 1203 denotes a printing executing button described below, and Reference numeral 1204 denotes a measurement starting button described below.

The user selects the desired sheet type and sheet size from the menus 1201 and 1202, and pushes down the measurement page printing executing button 1203. When the image quality adjusting tool detects that the measurement page printing executing button 1203 is pressed down, the PCs 2102 to 2104 generate the PDL data for the measurement page to be printed, and transmits the generated PDL data as the print job to the MFP through the network 2101.

The PDL data for the measurement page to be printed includes, as the printing setting, an attribute for indicating a measurement page job for the image quality adjustment, and the sheet type/size set in the menus 1201 and 1202.

In the MFP having received the measurement page job, the MFP control section 106 causes the PDL data to be processed in the order of the RIP section 108, the output image processing section 109, and the printer section 113, and prints the measurement page.

Next, according to a not-illustrated guidance displayed by the MFP control section 106 on the operation section 107, the user places the printed measurement page on the platen of the MFP, and pushes down the measurement starting button 1204 of the image quality adjusting tool. When the image quality adjusting tool detects that the measurement starting button 1204 is pressed down, the MFP control section 106 issues a scan instruction for the measurement page placed on the platen to the MFP. In this case, the image quality adjusting tool instructs so that the measurement page is scanned in the sheet size which is previously set as an area to be scanned when the measurement page is printed.

The MFP control section 106 receives the scan instruction issued from the image quality adjusting tool through the network 2101 and the NIC section 103. In addition, the MFP control section 106 transfers the image data scanned from the input image processing section 101 to the RIP section 108. When receiving the image data obtained by scanning the measurement page, the RIP section 108 compares each color component of the received image data with the color component when the measurement page is printed, and updates the printer profile.

The image quality adjustments executed by the present system includes not only an image quality adjustment using the image quality adjusting tool to update the printer profile by the PC, but also an image quality adjustment updating the lookup table of the CMM section 402a from the adjustment/cleaning button 1103 of the user mode setting screen 1101 of the MFP. In this case, when the MFP control section 106 detects that the adjustment/cleaning button 1103 is pressed down, the MFP control section 106 itself generates the measurement page job for correcting the lookup table, and causes the RIP section 108 to execute the expanding processing to print the measurement page. After that, the MFP control section 106 causes the touch panel to display a screen for prompting that the measurement page is scanned, and when detecting the scan instruction by the user, the MFP control section 106 scans the measurement page, and corrects the lookup table. <Printing Processing Under the Consideration of the Image Quality Adjustment>

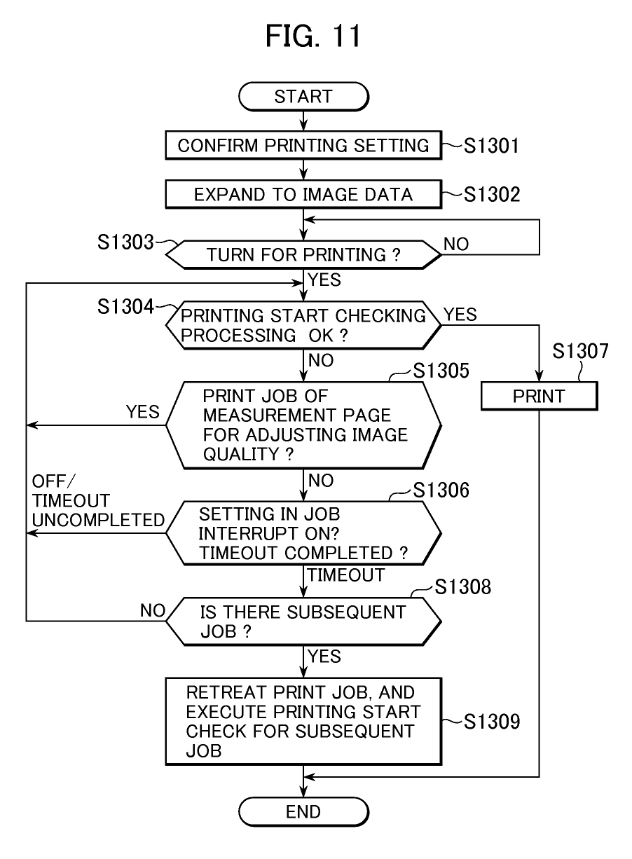

Next, the efficient printing processing under the consideration of the image quality adjustment in the present embodiment will be described by using FIG. 11.

FIG. 11 is a flowchart showing the procedure of the efficient printing process under the image quality adjustment in the present embodiment.

After receiving the print job, the MFP control section 106 causes the job analyzing section 203a to analyze the job setting information, and confirms the printing setting (step S1301). When the confirmation of the printing setting is completed, the MFP control section 106 causes the RIP section 108 to execute the expanding processing for the image data (step S1302) based on the analyzed job setting information. Here, at a time when the analysis of the job setting information is completed, the MFP control section 106 displays, as exemplified in FIG. 7A and FIG. 7B, the job in the job list displayed on the touch panel section 602.

When the expanding processing is completed, the MFP control section 106 causes the job to wait in step S1303 until its turn comes around for the job to execute the printing.

When the MFP control section 106 determines in step S1303 that the job's turn has come for executing the printing, in step S1304, the MFP control section 106 executes the printing start checking processing for the job. The printing start checking processing is such a processing that, based on the printing setting confirmed in step S1301 and a result of the expanding in step S1302, it is determined whether or not all the resources, which are necessary to execute the printing of the print job to be processed, are assembled in the printing apparatus. Here, when the MFP control section 106 determines that some of the resources is short, which are necessary for the printing of the job (NO in step S1304), the MFP control section 106 determines in step S1305 whether or not the job is the print job for the measurement page for the image quality adjustment.

When the MFP control section 106 determines that the job is not the print job for the measurement page for the image quality adjustment (NO in step S1305), the MFP control section 106 executes the following processing. That is, in the case where the “timeout setting in a job interrupt” is ON, the MFP control section 106 determines in step S1308 whether there exists a subsequent job waiting for its turn for printing after the job, for which it has been determined that there is still a shortage in the resource necessary for the printing even after a time of the timeout setting 1007 has passed over (timeout in step S1306). When it is determined that there does not exist the subsequent job (No in step S1308), the process returns to step S1304. On the other hand, when it is determined that there is the subsequent job (YES in step S1308), the process proceeds to step S1309 to execute retreating the job and the printing start checking processing for the subsequent print job.

On the other hand, when the MFP control section 106 determines that the job is the print job for the measurement page for the image quality adjustment (YES in step S1305), in step S1304, the MFP control section 106 continues to wait for the resource necessary for the printing to be supplied. In other words, it is prohibited to execute the subsequent print job (subsequent job) in priority to the print job for the measurement page. Even after the resource necessary for the printing for the print job of the measurement page is supplied, and the measurement page is printed, the MFP control section 106 controls so that the printing for the subsequent job is not executed for a certain time. This certain time is a time until the printed measurement page is scanned by a scanner, and the lookup table is corrected. Thereby, the subsequent job is executed after the image quality is adjusted by scanning the measurement page, so that the image quality can be adjusted before the subsequent job is executed.

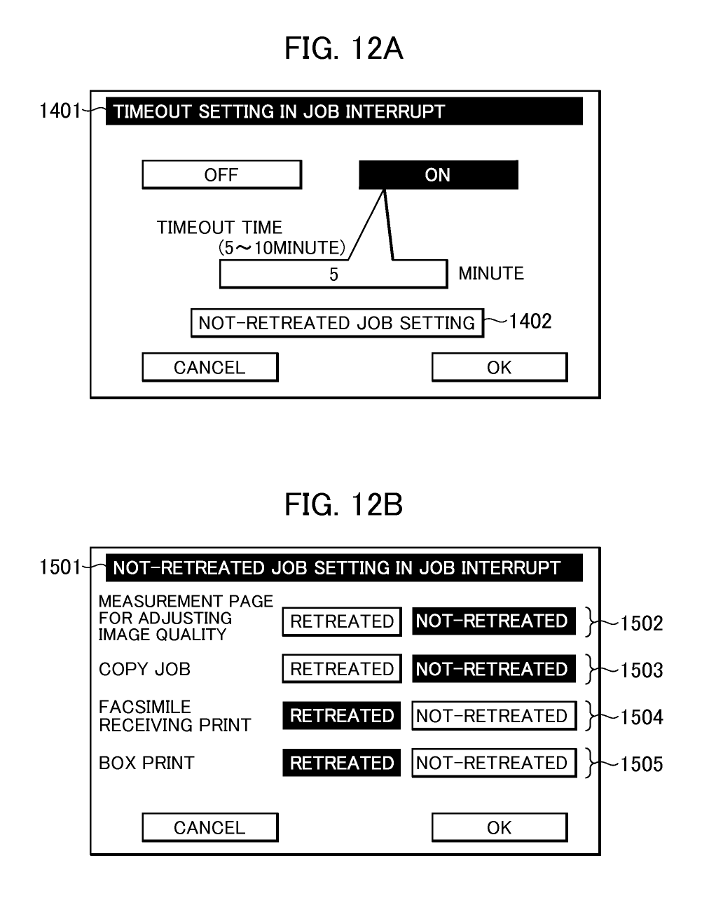

It is not necessary to limit the job in step S1305 to the print job of the measurement page for the image quality adjustment. That is, in the user mode screen, instead of the timeout setting in a job interrupt screen 1104 (FIG. 9A and FIG. 93), the timeout setting in a job interrupt screen 1401 exemplified in FIG. 12A may be displayed. In this timeout setting in a job interrupt screen 1401, a “not-retreated” job setting keys 1402 is provided. When detecting that the “not-retreated job setting key” 1402 is pressed down, the MFP control section 106 displays a “not-retreated job setting screen” 1501 exemplified in FIG. 12B.

Here, it is possible to select the job for each printing function included by the MFP other than a measurement page for the image quality adjustment 1502, that is, a copy job 1503, a facsimile receiving print 1504, or a box print 1505. That is, in the “not-retreated job setting screen” 1501, for example, when the copy job 1503 is also selected as “not-retreated” other than the measurement page for the image quality adjustment 1502, the processing becomes as follows. That is, in step S1305, even when the job is not only the print job of the measurement page for the image quality adjustment, but also the print of the copy job, regardless of the timeout setting in a job interrupt, the MFP control section 106 continues to wait for the resource necessary for the printing to be supplied.

In the “not-retreated job setting screen” 1501, the setting is exemplified for each printing function included by the MFP. However, the setting is not limited to this case, and based on the printing setting determined in step S1301 and step S1302 such as a specific sheet type, a sheet size, or the job whose printed matter includes a color image, the user can set whether or not the job is a not-retreated job.

According to the present embodiment, as illustrated in FIG. 8, when there is a shortage in the resource necessary for the printing of the print job (step S1004), from the viewpoint of the productivity, it is possible to temporarily stop the printing processing for the print job and to start the subsequent print job in priority to the stopped print job. For the processing, it is enough to set the “timeout setting in a job interrupt” (the screen of FIG. 9B) to ON.

However, even when the printing of the subsequent print job is started by priority, a timer is provided, and when the resource is not supplied even after e.g. five minutes-waiting, the subsequent print job is started. Thereby, it is possible to efficiently improve the productivity of the printed matter and to efficiently supply the resource.

When the resource is short, which is necessary to execute the printing for the print job for the image quality adjustment, it is prohibited to start the subsequent print job by priority (step S1304 and step S1305 of FIG. 11). That is, the subsequent print job is not started by priority, and the resource is waited for to be supplied, which is necessary to execute the job for the image quality adjustment. Thereby, it is possible to ensure the execution of the printing of the print job for the image quality adjustment before the subsequent print job. Thus, even in the printing environment such as the POD system, it is possible to efficiently realize, without causing the user to execute a complicated operation, both of the productivity improvement of the printed matter because of the reduction of the downtime of the printing apparatus, and the maintenance of the high image quality of the printed matter.

Here, the print job for the image quality adjustment includes the adjusting of the image quality for recording the image in a sheet, and the adjusting of the image quality for causing the RIP section 108 to expand the image.

In this case, when the MFP control section 106 receives the print job for the image quality adjustment, and the job list includes the print job for the image quality adjustment, it is desirable to cause the MFP control section 106 to execute the expanding processing for the subsequent job after it is completed to adjust the image quality.

Thus, when the MFP control section 106 receives the print job for the image quality adjustment, and the job list includes the print job for the image quality adjustment, the MFP control section 106 does not start the expanding processing for the print job received after the print job for the image quality adjustment is received. After it is completed to execute the printing for the print job for the image quality adjustment, the MFP control section 106 starts the expanding processing. In a second embodiment described below, such a method will be described.

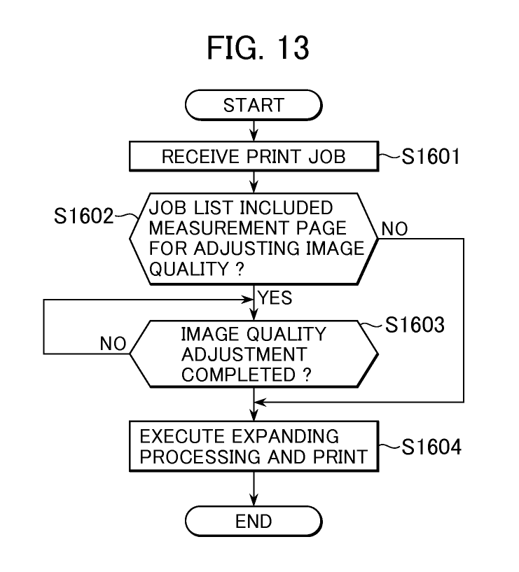

In the image forming system of the above first embodiment, the processing when the printing instruction is issued for the measurement page for the image quality adjustment will be described by using FIG. 13.

FIG. 13 is a flowchart showing the procedure of the printing process under the consideration of the image quality adjustment, which is executed by the MFP functioning as the printing apparatus according to the second embodiment of the present invention.

In FIG. 13, when receiving the print job in step S1601, and before starting the expanding processing in step S1602, the MFP control section 106 confirms the job included in the job list. When the MFP control section 106 detects in step S1602 that the job list includes the print job of the measurement page for the image quality adjustment, the MFP control section 106 executes the following processing in step S1603. That is, until a series of the image quality adjusting processings of the printing, the scan, and the update of the printer profile for the measurement page are completed, the MFP control section 106 waits without starting the expanding processing for the received print job.

In this case, while waiting without starting the expanding processing for the print job received for the image quality adjusting processing, the MFP control section 106 displays a job status 904 of the received print job as “Image Quality Adjustment Queue” in the job condition screen 900. When detecting in step S1603 that the image quality adjusting processing is completed, in step S1604, the MFP control section 106 causes the RIP section 108 to execute the expanding processing, and prints the expanded image data.

When the image quality is not adjusted for the printer profile, but the image quality is adjusted for the lookup table, in which the density correction is executed for the CMM section 402a of the output image processing section 109 which is not related to the RIP section 108 executing the expanding processing, the MFP control section 106 executes the processing as follows. The MFP control section 106 has completed the expanding processing, and waits for the image quality adjusting processing in step S1603 to be completed. When detecting that the image quality adjusting processing is completed, the MFP control section 106 starts printing the expanded image data.

As described above, according to the present embodiment, after the adjusting processing for the expanding processing is completed, the expanding processing for the subsequent print job can be executed.

It is assumed that the user desires to be able to execute the printing for the specific job in priority to the image quality adjustment. In a third embodiment described below, an example of the printing processing, which is preferable for such a case, will be described.

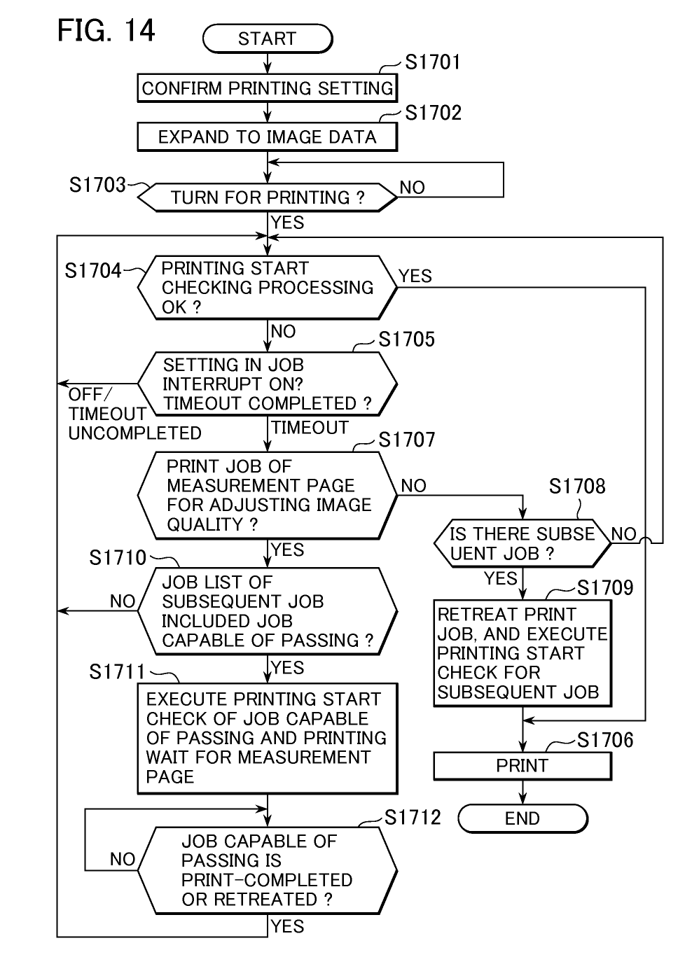

FIG. 14 is a flowchart showing the procedure of the printing processing executed by the MFP functioning as the printing apparatus according to the third embodiment of the present invention.

The processes of steps S1701 to S1706 are the same as the processes of steps S1001 to S1006 of the first embodiment. The MFP control section 106 executes the following processing in step S1707. That is, in the case where the “timeout setting in a job interrupt” is ON, the MFP control section 106 determines whether the job, for which it has been determined that there is still a shortage in the resource necessary for the printing even after a time of the timeout setting 1007 has passed over (timeout in step S1705), is the print job of the measurement page for the image quality adjustment. When the MFP control section 106 determines that the job is not the print job of the measurement page for the image quality adjustment (NO in step S1707), in step S1708 and step S1709, the MFP control section 106 executes the same processings as those of step S1007 and step S1008.

On the other hand, when the MFP control section 106 determines that the job is the print job of the measurement page for the image quality adjustment (YES in step S1707), the MFP control section 106 executes the following processing at S1710. That is, the MFP control section 106 determines whether the job, whose printing can pass the printing of the measurement page for the image quality adjustment, is included in the jobs waiting for its turn for printing after the job. When the MFP control section 106 determines that the job, whose printing can pass the printing of the measurement page for the image quality adjustment, is not included (NO in step S1710), the NFP control section 106 continues to waits for the necessary resource to be supplied.

On the other hand, when the MFP control section 106 determines that the job, whose printing can pass the printing of the measurement page for the image quality adjustment, is included (YES in step S1710), the MFP control section 106 executes the printing start checking processing for the job whose printing can pass the printing of the measurement page (step S1711). In addition, in step S1711, the MFP control section 106 designates the print job of the measurement page for the image quality adjustment to be “Printing Queue” in the job list. The MFP control section 106 waits for the printing start checking processing for the measurement page for the image quality adjustment until the job capable of passing is completed for the printing, or is retreated (step S1712).

The job whose printing can pass the printing of the measurement page for the image quality adjustment can be set from the “timeout setting in a job interrupt” button 1102 of the user mode setting screen 1101. As the description of FIG. 12A in the first embodiment, the job for each printing function included by the MFP, that is, the copy job, the facsimile receiving print, or the box print is selected. The printing setting may be the printing setting determined in step S1701 and step S1702 such as a sheet type, a sheet size, or the job whose printed matter is made up of a black and white image. For example, when the image quality adjustment executed by the print job for the measurement page for the image quality adjustment is the image quality adjustment for the color printing, it can be determined that a monochrome job whose printed matter is made up of the black and white image is the job capable of passing.

In the setting for the job whose printing can pass the printing of the measurement page for the image quality adjustment, the PCs 2102 to 2104 may also cause the PDL data of each print job to include a job capable of passing attribute as the printing setting. An interrupt job may be designated to be the job capable of passing. Thereby, the control under the intention of the user can be executed.

In the second embodiment, the print job including the job capable of passing attribute may be expanded without waiting for the image quality adjusting processing.

According to the present embodiment, when the resource is short, which is necessary to execute the printing for the print job for the image quality adjustment, the condition is that it is prohibited to start the subsequent print job by priority. However, when the subsequent print job includes the specific job (job capable of passing, that is, the job which is permitted by the user to be executed in priority to the print job for the image quality adjustment), the printing processing is started in priority to the print job for the image quality adjustment. Thereby, the productivity of the printed matter and the image quality adjustment can be finely balanced for each job.

In the third embodiment, such a case is described that, when the MFP control section 106 determines that regarding the job for the image quality adjustment, the printing interrupting factor occurs, the MFP control section 106 determines whether or not the passing is permitted by the user in priority to the job, and controls based on a result of the determination. Specifically, such a case is described that, based on the result of the determination, the MFP control section 106 executes the printing for the subsequent job, which is permitted to pass, in priority to the job regarding which it is determined that the printing interrupting factor occurs. However, the embodiment is not limited to such a case, and the MFP control section 106 may execute the following control. For example, based on information on the subsequent job, the MFP control section 106 determines whether or not the subsequent job is the job capable of passing, and may execute the control based on a result of the determination. For example, when the subsequent job is the job (for example, the print job or the copy job) which is influenced by the image quality adjustment, the MFP control section 106 restricts such a subsequent job to be executed in priority to the job regarding which it is determined that the printing interrupting factor occurs. On the other hand, when the subsequent job is the job (for example, the scan job or the data transmission job) which is not influenced by the image quality adjustment, the MFP control section 106 permits (does not restrict) such a subsequent job to be executed in priority to the job regarding which it is determined that the printing interrupting factor occurs.

In the above embodiments, the print job for the image quality adjustment, and other print job are independent from each other, and are not controlled as being related to each other. However, the following control may be executed. For example, when receiving the print job for the image quality adjustment, the MFP control section 106 causes the user to designate other specific job. The MFP control section 106 relates and stores the print job for the image quality adjustment and the specific job designated by the user. Thereby, the MFP control section 106 can control as follows. When it is determined that regarding the print job for the image quality adjustment, the printing interrupting factor occurs, the MFP control section 106 prohibits that the specific job related to the print job for the image quality adjustment is executed in priority to the print job for the image quality adjustment. The MFP control section 106 permits that the print job other than the specific job is executed in priority to the print job for the image quality adjustment. By controlling as described above, the user maintains the image quality of the specific job, and also, causes other print job to be executed, thereby, the productivity is prevented from being lowered. A method for designating the specific job includes the following (1) to (3). (1) The print job, which is registered in the MFP and is waiting for the printing, is designated before the print job for the image quality adjustment. (2) After registering the print job for the image quality adjustment in the MFP, the print job registered in the MFP is designated. (3) Both of the print job for the image quality adjustment and the specific print job are registered in the MFP to be designated. If the user has associated the print job for the image quality adjustment even though a specific print job is to be executed before the print job for the image quality adjustment, the MFP control section 106 may cause the specific job to wait for printing. When the execution of the print job for the image quality adjustment is completed, the MFP control section 106 may execute the printing for the specific job.

In the above embodiments, while such a case is described that the MFP control section 106 included by the MFP executes a variety of controls, the embodiment is not limited to such a case, and a variety of the above controls may be executed by the information processing apparatus such as the PC connected to the MFP. In this case, it is necessary the information processing apparatus can obtain the condition of the resource existing in the MEP and information on the job stored in the MFP. Based on the obtained information, the information processing apparatus controls to determine whether or not there exists the resource necessary for executing the job stored in the MFP, or to execute the subsequent job in priority to the job which is determined to include the printing interrupting factor.

It is to be understood that the object of the present invention may also be accomplished by supplying a system or an apparatus with a storage medium in which a program code of software which realizes the functions of the above described embodiment is stored, and causing a computer (or CPU or MPU) of the system or apparatus to read out and execute the program code stored in the storage medium. The program code is also referred to as a computer program.

In this case, the program code itself read from the computer-readable storage medium realizes the functions of any of the embodiments described above, and hence the program code and the storage medium in which the program code is stored constitute the present invention.

Examples of the storage medium for supplying the program code include a floppy (registered trademark) disk, a hard disk, a magnetic-optical disk, a CD-ROM, a CD-R, a CD-RW, a DVD-ROM, a DVD-RAM, a DVD-RW, a DVD+RW, a magnetic tape, a nonvolatile memory card, and a ROM. Alternatively, the program may be downloaded via a network.

Further, it is to be understood that the functions of the above described embodiment may be accomplished not only by executing a program code read out by a computer, but also by causing an OS (operating system) or the like which operates on the computer to perform a section or all of the actual operations based on instructions of the program code.

Further, it is to be understood that the functions of the above described embodiment may be accomplished by writing a program code read out from the storage medium into a memory provided on an expansion board inserted into a computer or in an expansion unit connected to the computer and then causing a CPU or the like provided in the expansion board or the expansion unit to perform a section or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2007-268010, filed Oct. 15, 2007, which is hereby incorporated by reference herein in its entirety.

What is claimed is:

1. A printing apparatus for performing a printing processing of a job, comprising:
a first determining unit adapted to determine whether a printing interrupting factor occurs regarding the job for which the printing processing is performed;
a control unit adapted to control to perform a subsequent job following the job in priority to the job, when said first determining unit determines that the printing interrupting factor occurs regarding the job; and
a restriction unit adapted to restrict, when the job, regarding which, it is determined that the printing interrupting factor occurs, is the job related to image quality adjustment, the subsequent job to be performed in priority to the job regarding which, it is determined that the printing interrupting factor occurs.

2. A printing apparatus as claimed in claim 1, further comprising a second determining unit adapted to determine whether the subsequent job is the job influenced by performing the job related to the image quality adjustment,
wherein, based on a result of the determination by said second determining unit, said restriction unit restricts said control unit to perform the subsequent job in priority to the job regarding which, it is determined that the printing interrupting factor occurs.

3. A printing apparatus as claimed in claim 1, further comprising a third determining unit adapted to determine whether the subsequent job is permitted to be performed in priority to the job regarding which, it is determined that the printing interrupting factor occurs,
wherein, based on a result of the determination by said third determining unit, said control unit performs the subsequent job in priority to the job.

4. A printing apparatus as claimed in claim 3, further comprising a setting unit adapted to set the job, for which the printing processing is performed, to be permitted to be performed in priority to the job regarding which, it is determined that the printing interrupting factor occurs.

5. A printing apparatus as claimed in claim 1, wherein, when there does not exist a resource which is necessary to perform the job, said first determining unit determines that the printing interrupting factor occurs regarding the job.

6. A job processing method for performing a printing processing of a job, comprising:
a first determining step of determining whether a printing interrupting factor occurs regarding the job for which the printing processing is performed;
a control step of controlling to perform a subsequent job following the job in priority to the job, when it is determined that the printing interrupting factor occurs regarding the job in said first determining step; and
a restriction step of restricting, when the job, regarding which, it is determined that the printing interrupting factor occurs, is the job related to image quality adjustment, the subsequent job to be performed in priority to the job regarding which, it is determined that the printing interrupting factor occurs.

7. A job processing method as claimed in claim 6, further comprising a second determining step of determining whether the subsequent job is the job influenced by performing the job related to the image quality adjustment,
wherein, based on a result of the determination in said second determining step, the subsequent job is restricted to be performed in priority to the job regarding which, it is determined that the printing interrupting factor occurs.

8. A job processing method as claimed in claim 6, further comprising a third determining step of determining whether the subsequent job is permitted to be performed in priority to the job regarding which, it is determined that the printing interrupting factor occurs,
wherein, based on a result of the determination in said third determining step, said the subsequent job is performed in priority to the job.

9. A job processing method as claimed in claim 8, further comprising a setting step of setting the job, for which the printing processing is performed, to be permitted to be performed in priority to the job regarding which, it is determined that the printing interrupting factor occurs.

10. A job processing method as claimed in claim 6, wherein, when there does not exist a resource which is necessary to perform the job, it is determined in said first determining step that the printing interrupting factor occurs regarding the job.

11. A program for causing a computer to execute a job processing method for performing a printing processing of a job, comprising:
a determining module for determining whether a printing interrupting factor occurs regarding the job for which the printing processing is performed;
a control module for controlling to perform a subsequent job following the job in priority to the job, when it is determined that the printing interrupting factor occurs regarding the job in said determining module; and
a restriction module for restricting, when the job, regarding which, it is determined that the printing interrupting factor occurs, is the job related to image quality adjustment, the subsequent job to be performed in priority to the job regarding which, it is determined that the printing interrupting factor occurs.

12. A computer-readable storage medium storing a program for causing a computer to execute a job processing method for performing a printing processing of a job, the program comprising:
a determining module for determining whether a printing interrupting factor occurs regarding the job for which the printing processing is performed;
a control module for controlling to perform a subsequent job following the job in priority to the job, when it is determined that the printing interrupting factor occurs regarding the job in said determining module; and
a restriction module for restricting, when the job, regarding which, it is determined that the printing interrupting factor occurs, is the job related to image quality adjustment, the subsequent job to be performed in priority to the job regarding which, it is determined that the printing interrupting factor occurs.
